(19) United States
(12) Patent Application Publication
(10) Pub. No.: US 2017/0228241 A1
(43) Pub. Date: Aug. 10, 2017

(54) ACCELERATION SYSTEM AND DRIVING METHOD THEREOF

(71) Applicant: ELECTRONICS AND TELECOMMUNICATIONS RESEARCH INSTITUTE, Daejeon (KR)

(72) Inventors: Yong Joo KIM, Daejeon (KR); Kyung Hee LEE, Daejeon (KR); Chae Deok LIM, Daejeon (KR)

(21) Appl. No.: 15/045,057

(22) Filed: Feb. 16, 2016

(30) Foreign Application Priority Data
Feb. 4, 2016 (KR) 10-2016-0013871

(51) Int. Cl. G06F 9/445; G06F 15/80

(52) U.S. Cl. CPC G06F 9/44505; G06F 15/80

(57) ABSTRACT

Provided herein are an acceleration system and a driving method thereof. The acceleration system includes a configuration memory, and a plurality of processing units which receive works from the configuration memory, perform the received works, and output results of the performed works. Each of the processing units include an n (n is an integer of three or more) number of processing elements which generate an n number of results, and each of which receives one of the works, and a select module which selects, using a majority-vote system, one of the n number of generated results and generates a selected result.

### CROSS-REFERENCE TO RELATED APPLICATION

The present application claims priority to Korean patent application number 10-2016-0013871 filed on Feb. 4, 2016 the entire disclosure of which is incorporated herein in its entirety by reference.

### BACKGROUND

Field of Invention

Various embodiments of the present disclosure relate to an acceleration system and a driving method thereof.

Description of Related Art

FIG. 1A is a view illustrating an acceleration system according to an embodiment of the present disclosure. The acceleration system shown in FIG. 1A includes a reconfigurable accelerator. The reconfigurable accelerator is an accelerator which is disposed at an intermediate position between an existing hardware accelerator and a processor. The acceleration system shown in FIG. 1A includes processing elements PE. FIG. 1B is a view illustrating a processing element in the acceleration system of FIG. 1A. Configuration between the processing elements PE may be changed depending on required work. The hardware accelerator is able to rapidly process a certain work through acceleration with low power consumption but is disadvantageous in that it is able to process only a given work. On the other hand, the processor is able to process a variety of works while performing a program but is disadvantageous in that it is slow and requires high power consumption. The reconfigurable accelerator is an accelerator which has the advantages of both the hardware accelerator and the processor. In other words, the reconfigurable accelerator is able to rapidly process a variety of works with low power consumption through reconfiguration.

However, as the range of use of the reconfigurable accelerator is widened, various specifications of reconfigurable accelerators are required. For example, high performance may be required, low power consumption may be required, or high reliability may be required. Such specifications may be changed depending on work to be processed, and there is a problem in that it is not easy to satisfy all specifications for all works.

Particularly, in the case where high reliability is required, there is the need to prevent the reliability of the reconfigurable accelerator from deteriorating due to a soft error. The soft error is a phenomenon in which bits stored in a transistor are temporarily reversed due to an external alpha particle or neutron. Such errors are becoming increasingly common along with reduction in weight, size and power consumption of an embedded processor. Many studies on this for the reconfigurable accelerator have not yet been carried out.

### SUMMARY

Various embodiments of the present disclosure are directed to an acceleration system which uses different processing methods depending on work to be processed and thus is able to satisfy various situational requirements, and a driving method thereof.

One embodiment of the present disclosure provides an acceleration system including: a configuration memory; and a plurality of processing units configured to receive works from the configuration memory, perform the received works, and output results of the performed works. Each of the processing units includes: an n (n is an integer of three or more) number of processing elements configured to generate an n number of results, each of the processing elements being configured to receive one of the works; and a select module configured to select, using a majority-vote system, one of the n number of generated results and generate a selected result.

In an embodiment, the acceleration system may further include: a control unit configured to control whether the select modules are operated, wherein in the case where reliability is required, the control unit transmits a reliability control signal to the configuration memory and controls the acceleration system such that the select modules are operated.

In an embodiment, the configuration memory may include a duplicator. In the case where the configuration memory receives the reliability control signal, the duplicator may generate the works through duplication.

In an embodiment, in the case where the select module is operated, the processing elements may perform the same work. Each of the processing units may output the selected result.

In an embodiment, when it is impossible to select one of the n number of generated results, the select module may output an exception signal.

In an embodiment, in the case where the select module is not operated, the respective processing elements may perform different works. The respective processing units may output the n number of generated results.

In an embodiment, the select module may include: a voter configured to determine, based on numbers of times the generated results overlap, a result of which the number of times of overlapping is largest, as the selected result; and a share register configured to store a result from the voter.

Another embodiment of the present disclosure provides a method of driving an acceleration system, including: determining whether a select module is operated; inputting works to processing units; performing the works and generating results; and generating a selected result based on the generated results, wherein the generating of the selected result based on the generated results is performed only when the select module is operated.

In an embodiment, the generating of the selected result based on the generated results may include: calculating numbers of times the generated results overlap; comparing the numbers of times of overlapping; and determining, among the results, a result of which the number of times of overlapping is largest as the selected result.

In an embodiment, whether the select module is operated may be determined based on whether a reliability requirement signal is received from the outside.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1A is a view illustrating an acceleration system according to an embodiment of the present disclosure;

FIG. 1B is a view illustrating a processing element in the acceleration system of FIG. 1A.

FIG. 2 is a diagram illustrating an acceleration system according to an embodiment of the present disclosure;

FIG. 3 is a diagram illustrating a processing element of the acceleration system of FIG. 2;

FIG. 4 is a diagram illustrating a processing unit of the acceleration system of FIG. 2;

FIGS. 5 to 7 are diagrams illustrating the operation of the acceleration system of FIG. 2 in the case of a reliability mode;

FIGS. 8 and 9 are diagrams illustrating the operation of the acceleration system of FIG. 2 except for the case of reliability mode;

FIG. 10 is a flowchart showing a method of driving the acceleration system according to an embodiment of the present disclosure; and

FIG. 11 is a flowchart illustrating step S1500 of FIG. 6.

### DETAILED DESCRIPTION

Hereinafter, embodiments according to the present disclosure will be described in detail with reference to the accompanying drawings. Like reference numerals refer to like elements throughout the specification. If in the specification, detailed descriptions of well-known functions or configurations would unnecessarily obfuscate the gist of the present disclosure, the detailed descriptions will be omitted. The names of elements that are used in the following description are to be selected in consideration of the ease of creating the specification and thus may differ from those of elements of an actual product.

It will be understood that when an element is referred to as being “coupled” or “connected” to another element, it can be directly coupled or connected to the other element or intervening elements may be present therebetween. In the specification, when an element is referred to as “comprising” or “including” a component, it does not preclude another component but may further include other components unless the context clearly indicates otherwise.

FIG. 2 is a diagram illustrating an acceleration system according to an embodiment of the present disclosure. The acceleration system 100 according to the present disclosure includes processing units 110, a configuration memory 120 and a control unit 130.

The processing units 110 receive works from the configuration memory 120, perform the received works, and output results of the performed works. The processing units 110 may include processing units PU-1 and PU-2. Because the processing units have the same structure, only the processing unit PU-1 will be described.

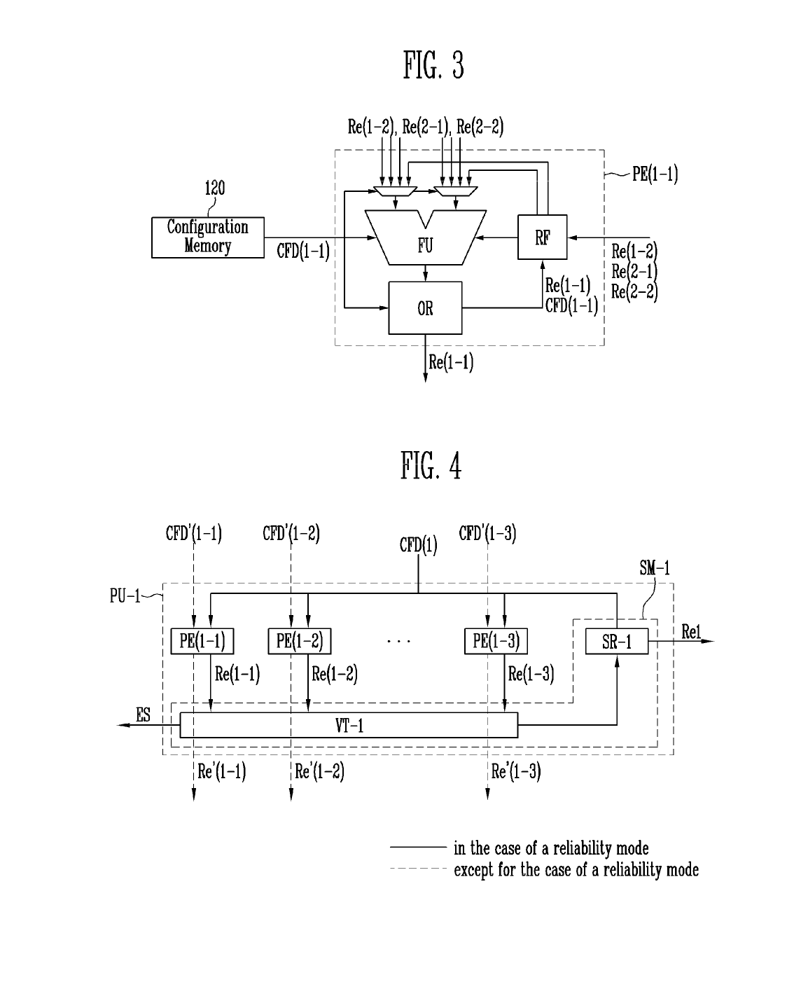

The processing unit PU-1 further includes not only processing elements PE(1-1) to PE(1-3) but also a voter VT-1 and a share register SR-1. When high reliability is required, the voter VT-1 and the share register SR-1 may be operated. When low power and high performance are required, the voter VT-1 and the share register SR-1 may not be operated. Detailed configuration of the processing unit PU-1 will be described in more detail with reference to FIG. 4.

Each of the processing elements PE(1-1) to PE(1-3) in the processing unit PU-1 receives one of works CFD from the configuration memory 120, performs the received work, and outputs a result of the performed work. Because the processing elements have the same structure, only the processing element PE(1-1) will be described in more detail with reference to FIG. 3.

The configuration memory 120 receives, in advance, works CFD from an external memory, and transmits the works CFD to the processing elements PE at each specific cycle. For the sake of explanation, it is assumed that the number of processing elements is twenty-four, and the number of select modules is eight.

In the case where the select modules are not operated as the high performance and low power are required, the configuration memory 120 transmits twenty-four works CFD to the respective processing elements at each cycle. The twenty-four processing elements output results of different works, and the acceleration system 100 outputs the twenty-four results to the outside.

In the case where the select modules are operated as the high reliability is required, the configuration memory 120 transmits eight works CFD to the respective processing elements repeatedly three times at each cycle. In this regard, since the processing elements PE(1-1), PE(1-2) and PE(1-3) in the processing unit PU-1 receive the same work, the eight select modules output eight results.

The control unit 130 controls the processing units 110 and the configuration memory 120. Furthermore, the control unit 130 determines whether the select modules are operated. The control unit 130 may control the select modules such that only when a reliability requirement signal TRS is received can the select modules be operated.

FIG. 3 is a diagram illustrating the processing element of the acceleration system of FIG. 2. For the sake of explanation, only the processing element PE(1-1) will be described.

The processing element PE(1-1) may include a functional unit FU, a register file RF, and an output register OR.

The functional unit FU receives a work CFD(1-1) among the works CFD and performs the received work CFD(1-1). In the case where the select modules are not operated, the functional unit FU may also receive results of processing elements PE(1-2), PE(2-1) and PE(2-2) neighboring to the processing element PE(1-1) and perform the work.

The register file RF may store intermediate values generated during calculation. The register file RF may receive results of the neighboring processing elements PE(1-2), PE(2-1) and PE(2-2) and transmit the stored results to the functional unit FU.

The output register OR outputs the result of calculation by the functional unit FU as a result Re(1-1). The result Re(1-1) may be outputted to the outside. Furthermore, the output register OR may store the work CFD(1-1) and transmit the result Re(1-1) or the work CFD(1-1) to the register file RF.

FIG. 4 is a diagram illustrating the processing unit of the acceleration system of FIG. 2. The processing unit PU-1 includes the processing elements PE(1-1) to PE(1-3) and the select module SM-1.

Each of the processing elements PE(1-1) to PE(1-3) receives one of the works CFD. The processing elements PE(1-1) to PE(1-3) generate three results. In the present embodiment, the single processing unit PU-1 includes the three processing elements PE(1-1) to PE(1-3), but this is only for illustrative purpose. In other words, the single processing unit PU-1 may include an n (n is an integer of three or more) number of processing elements. The n number of processing elements may generate the n number of results.

In the case of a reliability mode, the same work CFD(1) is inputted to the three elements PE(1-1), PE(1-2) and PE(1-3). The three elements PE(1-1), PE(1-2) and PE(1-3) perform separate works and generate three results Re(1-1), Re(1-2) and Re(1-3), respectively.

Except for the case of reliability mode, three different works CFD′(1-1), CFD′(1-2) and CFD′(1-3) are respectively inputted to the three elements PE(1-1), PE(1-2) and PE(1-3). The three elements PE(1-1), PE(1-2) and PE(1-3) perform separate works and generate three results Re′(1-1), Re′(1-2) and Re′(1-3), respectively.

The select module SM-1 includes a voter VT-1 and a share register SR-1 and is operated only in the case of the reliability mode. The voter VT-1 selects, using a majority-vote system, one among the results Re(1-1), Re(1-2) and Re(1-3) generated from the three processing elements PE(1-1), PE(1-2) and PE(1-3) and generates a selected result Re1. For example, in the case where the results Re(1-1) and Re(1-2) have the same value while only the result Re(1-3) has a different value, the result Re1 selected by the voter VT-1 has the same value as that of the results Re(1-1) and Re(1-2). The processing unit PU-1 outputs only the result Re1. If the results Re(1-1), Re(1-2) and Re(1-3) have all different values, the voter VT-1 is not able to select one value. In this case, the select module SM-1 outputs an exception signal ES.

Except for the case of the reliability mode, the select module SM-1 is not operated. Therefore the processing unit PU-1 outputs three results Re′(1-1), Re′(1-2) and Re′(1-3) as they are.

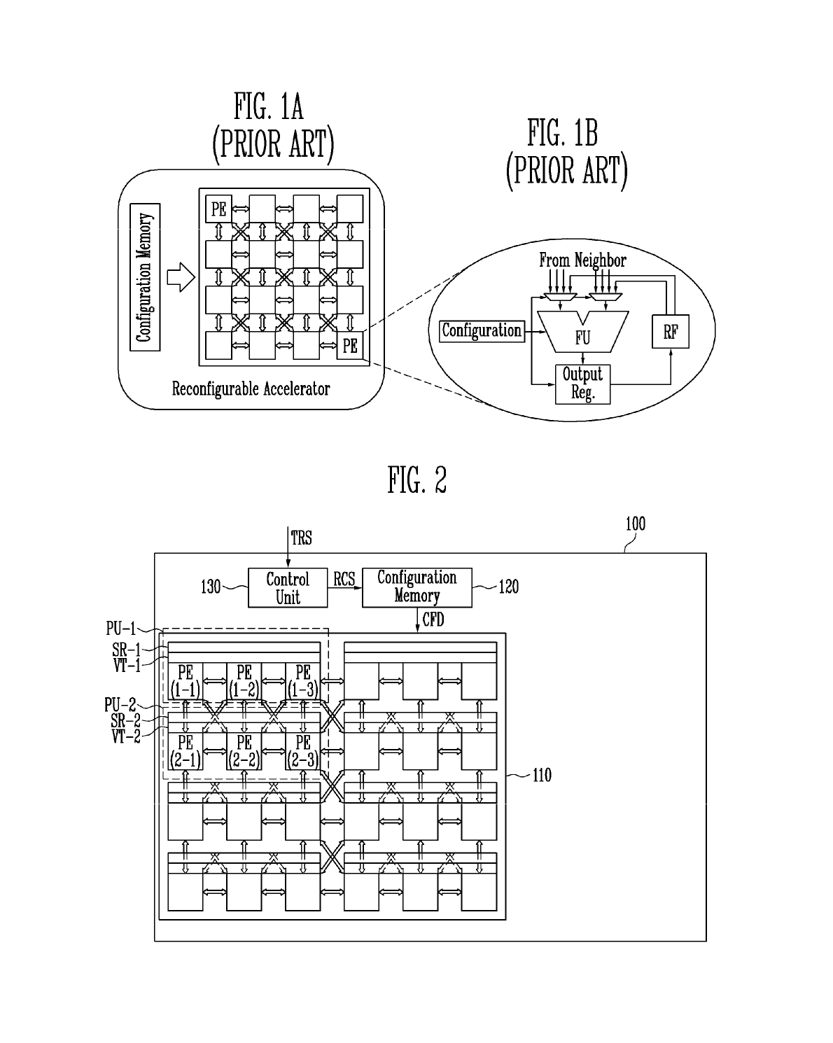

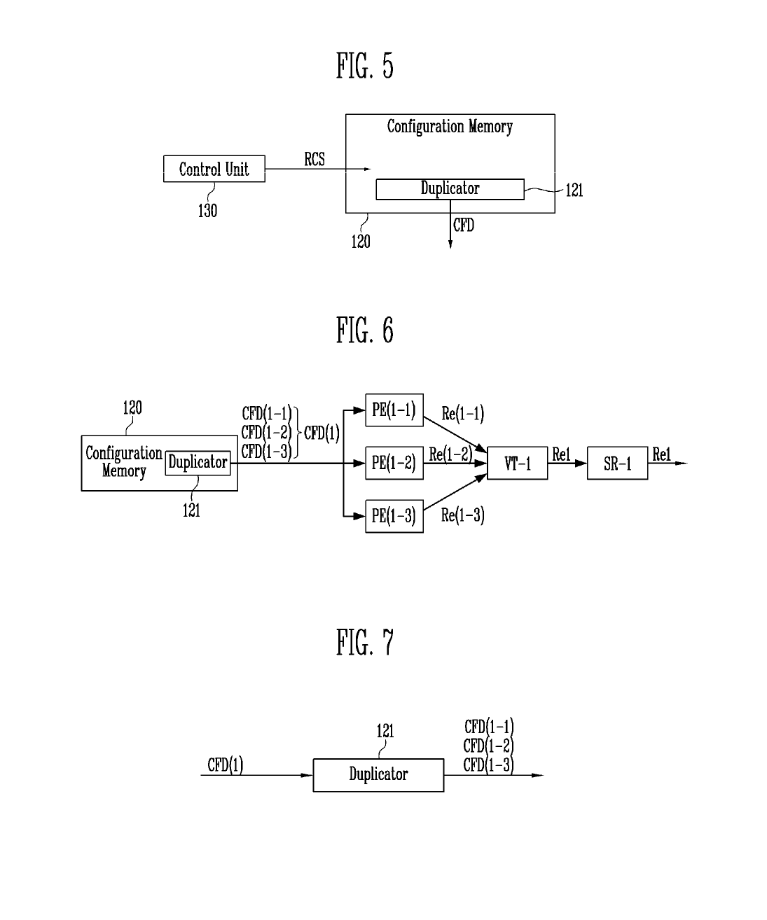

FIGS. 5 to 7 are diagrams illustrating the operation of the acceleration system of FIG. 2 in the case of the reliability mode. Hereinafter, the operation of the acceleration system of FIG. 2 will be described with reference with FIGS. 1 to 7.

FIG. 5 is a diagram illustrating the operation of the control unit and the configuration memory in the case of the reliability mode. In the reliability mode where high reliability is required, the control unit 130 transmits a reliability control signal RCS to the configuration memory 120 and controls it such that the select module SM-1 is operated. The configuration memory 120 includes a duplicator 121 and is controlled such that when a reliability control signal RCS is received, the duplicator 121 is operated. The duplicator 121 duplicates one work into three works and outputs them. That is, the works CFD are results of duplication using the duplicator 121.

FIG. 6 is a diagram illustrating the operation of the processing unit in the case where the select module is operated.

The configuration memory 120 transmits works CFD(1-1), CFD(1-2) and CFD(1-3) to the processing elements PE(1-1), PE(1-2) and PE(1-3), respectively. However, because the duplicator 121 is operated, the substantial contents of the works CFD(1-1), CFD(1-2) and CFD(1-3) are the same. Therefore, the works may be collectively called work CFD(1).

The processing elements PE(1-1), PE(1-2) and PE(1-3) perform in parallel the same work CFD(1) and output the results Re(1-1), Re(1-2) and Re(1-3). It may be assumed that the structures of the processing elements PE(1-2) and PE(1-3) are the same as that of the processing element PE(1-1). The results Re(1-1), Re(1-2) and Re(1-3) are inputted to the voter VT-1.

The voter VT-1 outputs, using the majority-vote system, one of the inputted results Re(1-1), Re(1-2) and Re(1-3) as a selected result Re1. In the case where there are three processing elements PE(1-1), PE(1-2) and PE(1-3), the voter VT-1 secures reliability using a triple modular redundancy (TMR) technique. Therefore, in the case where a reliability requirement signal TRS is received from the outside, the voter VT-1 is operated so as to increase the reliability. However, because the three processing elements PE(1-1), PE(1-2) and PE(1-3) perform the same work, the performance may deteriorate.

The share register SR-1 stores the result Re1 transmitted from the voter VT-1 and then outputs it to the outside.

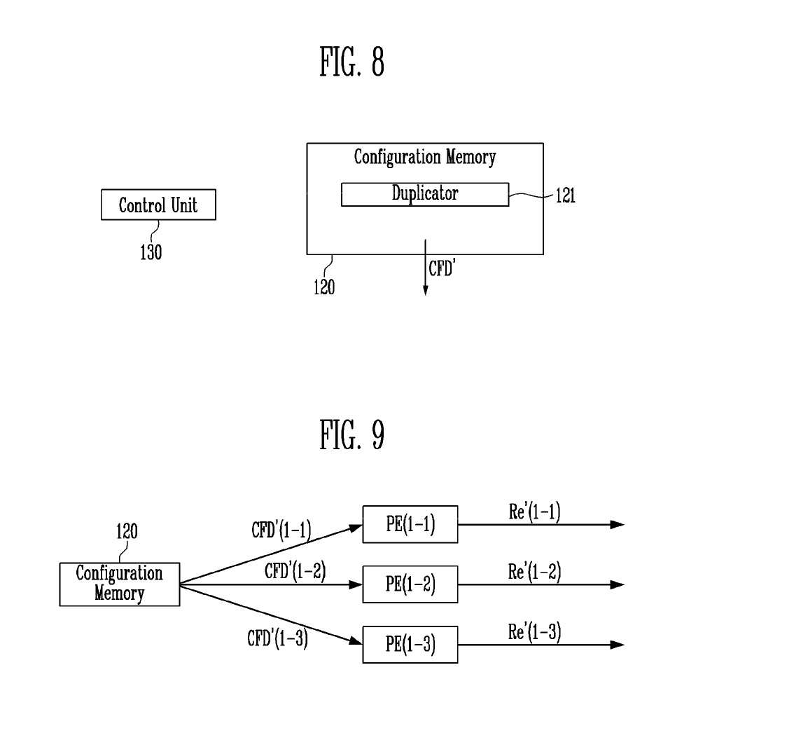

FIG. 7 is a diagram illustrating the operation of the duplicator of FIG. 5 in the case where the select module is operated. The duplicator 121 receives the work CFD(1) that has been previously stored in the configuration memory 120, duplicates it into three works CFD(1-1), CFD(1-2) and CFD(1-3), and transmits them to the processing elements PE(1-1), PE(1-2) and PE(1-3), respectively. That is, in the case where the select module SM-1 is operated, the same work CFD is inputted to the processing elements PE(1-1), PE(1-2) and PE(1-3).

FIGS. 8 and 9 are diagrams illustrating the operation of the acceleration system of FIG. 2 except for the case of the reliability mode. Hereinafter, the operation of the acceleration system of FIG. 2 will be described with reference with FIGS. 1 to 4, 8 and 9.

FIG. 8 is a view illustrating the operation of the controller and the configuration memory except the case of the reliability mode. Because except for the reliability mode, the control unit 130 does not transmit a reliability control signal RCS to the configuration memory 120. The configuration memory 120 outputs works CFD′ as they are, without operating the duplicator 121.

FIG. 9 is a diagram illustrating the operation of the processing unit except for the case of the reliability mode.

The configuration memory 120 transmits works CFD′(1-1), CFD′(1-2) and CFD′(1-3) to the processing elements PE(1-1), PE(1-2) and PE(1-3), respectively. However, because the voter VT-1 is not operated, the substantial contents of the works CFD′(1-1), CFD′(1-2) and CFD′(1-3) may not be the same.

The processing elements PE(1-1), PE(1-2) and PE(1-3) respectively perform the works CFD′(1-1), CFD′(1-2) and CFD′(1-3) and output results Re′(1-1), Re′(1-2) and Re′(1-3). It may be assumed that the structures of the processing elements PE(1-2) and PE(1-3) are the same as that of the processing element PE(1-1). The results Re′(1-1), Re′(1-2) and Re′(1-3) are outputted to the outside without passing through the voter VT-1.

In the case where a reliability requirement signal TRS is not received from the outside, the performance may be enhanced because the voter VT-1 is not operated. That is, the configuration memory 120 transmits different works CFD′(1-1), CFD′(1-2) and CFD′(1-3) to the processing elements PE(1-1), PE(1-2) and PE(1-3). The processing elements PE(1-1), PE(1-2) and PE(1-3) respectively perform the works CFD′(1-1), CFD′(1-2) and CFD′(1-3) and output different results Re′(1-1), Re′(1-2) and Re′(1-3). The results Re′(1-1), Re′(1-2) and Re′(1-3) are outputted to the outside without passing through the voter VT-1.

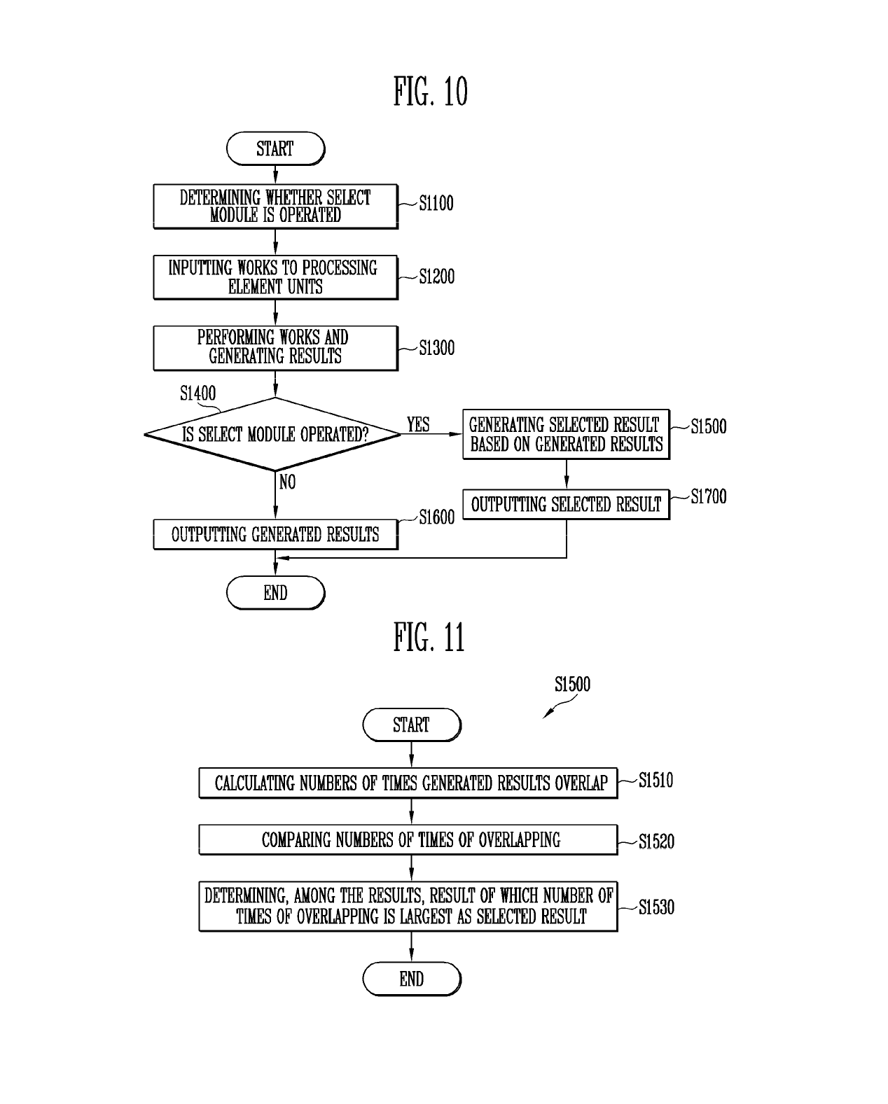

FIG. 10 is a flowchart showing a method of driving the acceleration system according to an embodiment of the present disclosure. Hereinafter, an embodiment of the method of driving the acceleration system according to the present disclosure will be described with reference to FIGS. 2 to 10. For the sake of explanation, only the processing unit PU-1 among the processing units 110 will be referred to in the following description.

At step S1100, the controller 130 determines whether the select module SM-1 is operated. In the case where a reliability requirement signal TRS is received from the outside, the control unit 130 may determine to operate the select modules. In the case where a reliability requirement signal TRS is not received from the outside, the control unit 130 may determine to not operate the select modules.

At step S1200, the configuration memory 120 inputs works CFD to the processing elements. The fact that when the select module SM-1 is operated, the three processing elements PE(1-1), PE(1-2) and PE(1-3) receive the same work CFD(1) has been described with reference to FIG. 6. The fact that when the select module SM-1 is not operated, the three processing elements PE(1-1), PE(1-2) and PE(1-3) receive different works CFD′(1-1), CFD′(1-2) and CFD′(1-3) has been described with reference to FIG. 9.

At step S1300, the processing elements PE(1-1), PE(1-2) and PE(1-3) perform the works and generate results. The fact that when the select module SM-1 is operated, the three processing elements PE(1-1), PE(1-2) and PE(1-3) perform the same work CFD(1) and generate the results Re(1-1), Re(1-2) and Re(1-3) has been described with reference to FIG. 4. The fact that when the select module SM-1 is not operated, the three processing elements PE(1-1), PE(1-2) and PE(1-3) perform different works CFD′(1-1), CFD′(1-2) and CFD′(1-3) and generate results Re′(1-1), Re′(1-2) and Re′(1-3) has been described with reference to FIG. 9.

At step S1400, when the select module SM-1 is operated, step S1500 is performed, and when the select module SM-1 is not operated, step S1600 is performed. Whether the select module SM-1 is operated has been determined at step S1100.

At step S1500, the select module SM-1 generates a selected result Re1 using a majority-vote system based on the results Re(1-1), Re(1-2) and Re(1-3). For example, in the case where the results Re(1-1) and Re(1-2) have the same value while only the result Re(1-3) has a different value, the result Re1 selected by the voter VT-1 has the same value as that of the results Re(1-1) and Re(1-2).

At step S1600, the results Re′(1-1), Re′(1-2) and Re′(1-3) generated by the processing elements PE(1-1), PE(1-2) and PE(1-3) are outputted to the outside. This has been described in detail with reference to FIG. 9.

At step S1700, the result Re1 selected by the select module SM-1 is outputted to the outside.

FIG. 11 is a flowchart illustrating step S1500 of FIG. 10. Hereinafter, step S1500 will be described in detail with reference to FIGS. 2 to 7 and 11. For the sake of explanation, it will be assumed that, as shown in FIG. 6, the voter VT-1 generates the selected result Re1 based on the results Re(1-1), Re(1-2) and Re(1-3) generated from the three processing elements PE(1-1), PE(1-2) and PE(1-3). Furthermore, for the sake of explanation, it is assumed that the results Re(1-1) and Re(1-2) have the same value but the result Re(1-3) has a different value.

At step S1510, the voter VT-1 calculates the numbers of times the results overlap. For the results Re(1-1) and Re(1-2), the number of times of overlapping is calculated as being two times, and for the result Re(1-3), one time.

At step S1520, the voter VT-1 compares the numbers of times of overlapping. The number of times the results Re(1-1) and Re(1-2) overlap is two times, and the number of times the result Re(1-3) overlaps is one time.

At step S1530, the voter VT-1 selects the results Re(1-1) and Re(1-2), of which the number of times of overlapping is largest, as the selected result Re1.

As described above, in an acceleration system and a driving method thereof according to an embodiment of the present disclosure, different processing methods can be used depending on work to be processed, whereby various situational requirements can be satisfied.

Although exemplary embodiments of the present disclosure have been described in detail, those with ordinary knowledge in this art will appreciate that various modifications, additions and substitutions are possible, without departing from the scope and spirit of the present disclosure. Therefore, the scope and spirit of the present disclosure should be defined by the accompanying claims rather than the detailed description of the specification.

What is claimed is:

1. An acceleration system comprising:
a configuration memory; and
a plurality of processing units configured to receive works from the configuration memory, perform the received works, and output results of the performed works,
each of the processing units comprising:
an n (n is an integer of three or more) number of processing elements configured to generate an n number of results, each of the processing elements being configured to receive one of the works; and
a select module configured to select, using a majority-vote system, one of the n number of generated results and generate a selected result.

2. The acceleration system according to claim 1, further comprising:
a control unit configured to control whether the select modules are operated,
wherein in a case where reliability is required, the control unit transmits a reliability control signal to the configuration memory and controls the acceleration system such that the select modules are operated.

3. The acceleration system according to claim 2,
wherein the configuration memory comprises a duplicator, and
wherein in a case where the configuration memory receives the reliability control signal, the duplicator generates the works through duplication.

4. The acceleration system according to claim 1,
wherein in a case where the select module is operated, the processing elements perform a same work, and
wherein each of the processing units outputs the selected result.

5. The acceleration system according to claim 1, wherein when it is impossible to select one of the n number of generated results, the select module outputs an exception signal.

6. The acceleration system according to claim 1,
wherein in a case where the select module is not operated, the respective processing elements perform different works, and
wherein the respective processing units output the n number of generated results.

7. The acceleration system according to claim 1, wherein the select module comprises:
a voter configured to determine, based on numbers of times the generated results overlap, a result of which the number of times of overlapping is largest, as the selected result; and
a share register configured to store a result from the voter.

8. A method of driving an acceleration system, comprising:
determining whether a select module is operated;
inputting works to processing units;
performing the works and generating results; and
generating a selected result based on the generated results,
wherein the generating of the selected result based on the generated results is performed only when the select module is operated.

9. The method according to claim 8, wherein the generating of the selected result based on the generated results comprises:
calculating numbers of times the generated results overlap;
comparing the numbers of times of overlapping; and
determining, among the results, a result of which the number of times of overlapping is largest as the selected result.

10. The method according to claim 8, wherein whether the select module is operated is determined based on whether a reliability requirement signal is received from an outside.
